(19) United States
(12) Patent Application Publication
(10) Pub. No.: US 2024/0054124 A1
(43) Pub. Date: Feb. 15, 2024

(54) MACHINE LEARNING-BASED DATABASE INTEGRITY VERIFICATION

(71) Applicant: AT&T Intellectual Property I, L.P., Atlanta (US)

(72) Inventors: Mohammad Nikain, Atlanta, GA (US); Daniel J. Connolly, Suwanee, GA (US)

(21) Appl. No.: 17/888,075

(22) Filed: Aug. 15, 2022

(51) Int. Cl. G06F 16/23

(52) U.S. Cl. CPC G06F 16/2358

(57) ABSTRACT

A processing system may obtain at least one set of records of changes to data elements of a plurality of data elements, where each record is associated a respective data element of the plurality of data elements and wherein each record comprises a timestamp and a type of a change to the respective data element. The processing system may then apply a detection model to the at least one set of records of the changes to the data elements to identify at least two related data elements of the plurality of data elements and output an indication of at least one relationship between the at least two related data elements.

The present disclosure relates generally to telecommunication network database records management and utilization, and more particularly to methods, computer-readable media, and apparatuses for applying a detection model to at least one set of records of changes to data elements of a plurality of data elements to identify at least two related data elements.

### BACKGROUND

A major factor in data quality is redundant data that exists in multiple systems with inconsistent values. In a telecommunication network having a software-defined networking (SDN) architecture, different locations in the telecommunication network may be provisioned with a common resource pool of network function virtualization infrastructure (NFVI), and to the extent possible, routers, switches, edge caches, middle-boxes, and the like, may be instantiated and terminated from the common resource pool. However, along with the increasing ease of making infrastructure changes in the telecommunication network, ever increasing volumes of data are collected and stored in relation to network operations, such as inventory records, operational data, and so forth. As such, while mechanisms exists to attempt to maintain consistent data across various systems, opportunities still arise for inconsistencies due to various reasons.

### SUMMARY

The present disclosure broadly discloses methods, non-transitory (i.e., tangible or physical) computer-readable media, and apparatuses for applying a detection model to at least one set of records of changes to data elements of a plurality of data elements to identify at least two related data elements. For instance, in one example, a processing system including at least one processor may obtain at least one set of records of changes to data elements of a plurality of data elements, where each record is associated a respective data element of the plurality of data elements and wherein each record comprises a timestamp and a type of a change to the respective data element. The processing system may then apply a detection model to the at least one set of records of the changes to the data elements to identify at least two related data elements of the plurality of data elements and output an indication of at least one relationship between the at least two related data elements.

### BRIEF DESCRIPTION OF THE DRAWINGS

The present disclosure can be readily understood by considering the following detailed description in conjunction with the accompanying drawings, in which:

FIG. 1 illustrates one example of a system including a telecommunication network, according to the present disclosure;

FIG. 2 illustrates example aspects of identifying relationships between data elements, in accordance with the present disclosure;

FIG. 3 illustrates an example relationship graph, in accordance with the present disclosure;

FIG. 4 illustrates a flowchart of an example method for applying a detection model to at least one set of records of changes to data elements of a plurality of data elements to identify at least two related data elements; and

FIG. 5 illustrates a high-level block diagram of a computing device specially programmed to perform the functions described herein.

To facilitate understanding, identical reference numerals have been used, where possible, to designate identical elements that are common to the figures.

### DETAILED DESCRIPTION

The present disclosure broadly discloses methods, non-transitory (i.e., tangible or physical) computer-readable media, and apparatuses for applying a detection model to at least one set of records of changes to data elements of a plurality of data elements to identify at least two related data elements. For instance, a major factor in data quality is redundant data that exists in multiple systems with inconsistent values. With respect to telecommunication network operations, the proliferation of Internet of Things devices, higher data rates on fiber-optic cable, and the expansion of 5G and other network technologies may increase the need for accurate network inventory data while at the same time making this task even more challenging. For example, within a telecommunication network, data inconsistencies may lead to substantial unused network resources, unavailable assets, unnecessary orders, and less effective provisioning/assurance (e.g., failures, prolonged troubleshooting, etc.). In this regard, examples of the present disclosure may identify and fix inconsistencies in data elements (or “data objects”) distributed over many systems without any prior knowledge of the relationships between data elements, redundancy, sources of records, or other predetermined factors. Examples of the present disclosure may also be combined with other data cleansing and exploration methods to achieve an even higher degree of accuracy.

In one example, the present disclosure may comprise an unsupervised machine learning (ML) process that determines relationships between data elements via time-domain (temporal) correlation of the data elements based on when and how the elements change and/or based on the correlation of data element changes to various events, e.g., network events. In addition, in one example, network events may be time-stamped such that event correlation may be expanded by creating a timeline of events and looking for correlations and relationships with past and future network events in addition to current network events. In one example, database changes (e.g., changes to any data elements thereof) are recorded and may include a classification of the change (e.g., add/insert, delete, modify/change, etc.), the affected data element(s) (e.g., a column, a row, and/or a table), and a timestamp. At least one set (or stream) of records comprising the times of changes along with the respective operations may be applied to an unsupervised machine learning algorithm (such as clustering) to identify related data elements. For instance, changes that occur in different data elements at the same time or with a consistent/predictable delay may be correlated.

In a similar way, network events may be timestamped, classified, and recorded. In general, “network events” may be indicated by application programming interface (API) calls to one or more systems in the telecommunication network. However, “network events” may also include trouble tickets, work order state changes, and other events that either instigate data updates or that are impacted by data changes. Different API calls may also be further classified by their operations. In some APIs, the nature of the operation may not be directly available without some manual labeling (e.g., a user tagging or entering guidance information). However, in many cases APIs follow industry standards (e.g. REST/SNMP/TMF, etc.) or local standards, which can be used to classify the API calls into categories of operations. This feature may be helpful to the algorithm, but is not necessary since it is not always available.

It should be noted that API calls may be correlated to changes of data elements in both source and destination systems as well as other systems (e.g., a data change may trigger a further outbound API call, or an inbound API call may trigger a data change, etc.). In one example, API calls may also be correlated to other API calls across the network (e.g., it may be learned that one API call always, or usually precedes another API call on another system). In one example, other events and circumstances may also be entered into an event pool that may be correlated with API calls and data changes (e.g., time of the day, day of the week/month, regularly scheduled maintenance windows, other “known” network events such as installations, expansions, etc.). In this case, the network or other events may be correlated, even if they occur in a time-shifted manner (e.g., at consistent/predictable delay). In one example, the present disclosure may also include a transitive correlation and extrapolation of relationships among data elements. For example, as relationships are identified in accordance with the present disclosure (or via other methods), examples of the present disclosure may further extrapolate relationship data to find additional relationships among other data elements (e.g., if A is related to B, and if B is related to C, then A may be related to C to some degree).

Thus, examples of the present disclosure determine relationships between data elements based on when, why, and/or how data changes over an extended period of time. Notably, this approach adds significant intelligence in gathering information to correlate data elements and determine relationships. In addition, once these additional correlations are identified, supervised and unsupervised machine learning processes may be made more effective in relating such data elements. Although examples of the present disclosure are described herein primarily in connection with telecommunication network inventory and operations, examples of the present disclosure may be further applicable to other systems having large inventories, systems that utilize substantial automated processes, and so forth. For instance, this may include utility systems (e.g., electric power utilities, water services, sanitary/sewerage services, natural gas services, and so forth), city management and operational systems (e.g., a large city may operate hundreds of subway cars, may maintain thousands of miles of track, switching equipment, etc., may maintain a network of traffic lights and other traffic signals, street lights, “smart city” sensors, etc.), organizations with large numbers of customer/account records (e.g., major online retailers, etc.), and so forth.

As noted above, in a large organization such as a telecommunication network, there may be a substantial number of systems performing overlapping and intersecting tasks, each collecting their own data. It is often difficult to perform data processing tasks that involve searching for and gathering data from different systems. As such, in some case, it may be preferred to just keep a redundant local copy, and to receive updates from time to time. In one example, a user, customer, subscriber, or the like may have a same address for billing, for service, etc. However, in reality, the different systems may store the same address data separately. In one example, a fault management system may use one version of data to find a problem, and another system may disagree because it does not see the same data. There are various methods to resolve data discrepancies and to identify similar data elements, e.g., looking at a field/column that appears to be addresses, a similar field/column may be found in another table that is called something else, but appears to also include addresses.

Existing methods may look to the nature of the data within a data element (e.g., a table, column, and/or row) to identify correlations/relationships between data elements. For instance, data elements with the same or similar high values, low values, mean values, median values, entropy metrics, uniqueness factors, etc. may be considered to be the same or similar data. In contrast, the present disclosure looks at changes in the data, rather than the data itself, e.g., how often does data change, does it always change following or preceding one or more other data changes, etc. For instance, it may be the case that addresses and phone numbers may usually be changed together (for instance, this may be the case when a home phone number is based on the city address (e.g., the first six digits or “NPA-NIXX”)). Thus, examples of the present disclosure use correlations of data changes to identify relationships of data elements. However, it should be noted that in one example, the present disclosure may further look to the data itself and/or the data structure (e.g., mean, median, entropy, etc.) to confirm that data elements are related (e.g., as a verification/check on the results of the relationships identified in accordance with the present disclosure).

It should be noted that in an ideal scenario, all data elements may be synchronized and in agreement. In reality, records may be substantially less accurate (or more inconsistent). For example, changes in corresponding data should be pre-programmed, or done manually, but personnel may forget to make a corresponding change in table B after making a change in table A, a script may fail to execute properly, an instruction to make a change in table B may fail, etc. The present disclosure automatically learns correlations to alleviate the need for expert domain knowledge, and may provide verification that humans do not miss entering changes, or that automated scripts or the like do not fail to carry forward changes in one system/table to corresponding changes in the other system/table.

To illustrate, at some point in time, someone may have programmed a script to perform automated data updates, and thus knows that there is related/correlated data elements. However, this knowledge may be lost, since the original programmer may no longer be employed with the company. Thus, there may be old scripts that may perform automated updates that no one is aware of, or the data may be updated in a visible way, but without anyone being quite sure as to the underlying purpose as to the updates. As an example, it may have been the case that in the past, service address and billing address were always the same. In turn, at some point in time, it may have become permissible to have different billing and service addresses. However, there may be an old script that was not disabled, and which may always update one when the other is changed under a particular scenario. Thus, when a billing address is changed, the old script may automatically activate and change the service address as well, while in fact it should no longer be performing this obsolete function. Examples of the present disclosure may identify these types of data elements as being related based on having similar patterns of data changes. It should be noted that the data elements may also have similar underlying data. But for purposes of the present disclosure, it is the relationship of the data changes that is identified, and that in one example, may be quantified. As these data elements may be identified as being related, based on having correlated data updating patterns, further data exploration may then discover and report discrepancies, automatically resolve such discrepancies, and so forth.

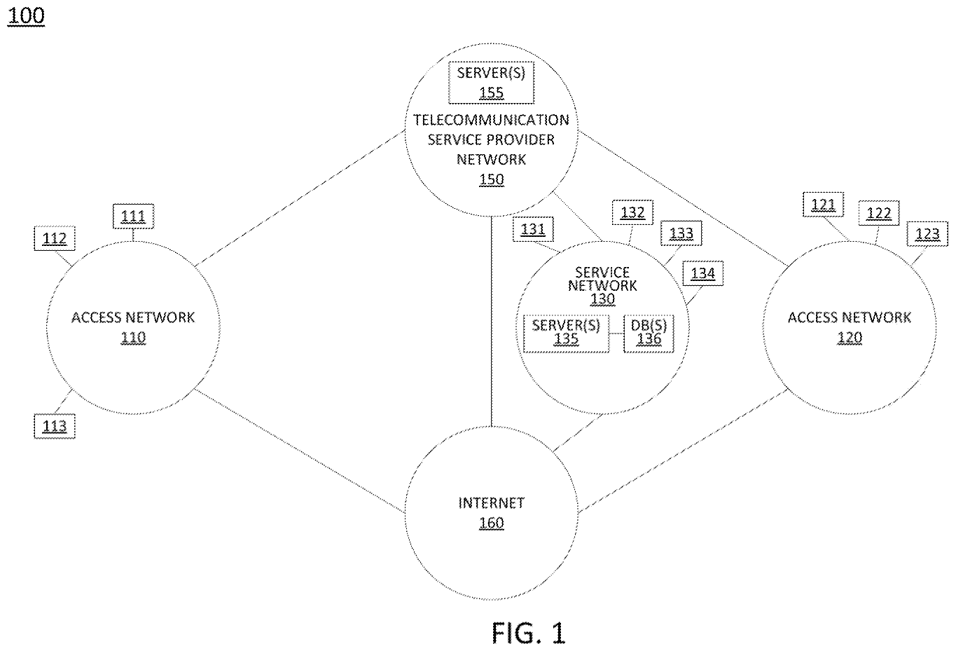

As noted above, data elements may comprise tables, table rows, and/or table columns. As such, in one example, related rows may show records about the same “resource” (customer, customer attribute, etc.). Related columns may show similarities in structure (schema) of the data. The combination of matching rows and structure, may help correlate specific pieces of data. Once this relationship is established, inference can be used to determine potential errors. For example, a “port status” (column name) in “devices” (table name) stored in an inventory management system may be set to a value of “adminUp.” However, in “state” (column name) in “equipment” (table name) stored in a different inventory system, the value may be set to “0.” In an illustrative example, a relationship detection model of the present disclosure may determine that the “devices” table in inventory system 1 is matched to the “equipment” table in inventory system 2. Further, the “port status” column may be found to be matched to the “state” column since the value of “adminUp” may be correlated with “1,” and “adminDown” may be correlated to “0.” For instance, it may be determined that when “adminUp” changed to “adminDown,” “1” should be changed to “0” in a correlated way. In one example, this may be identified via direct table-to-table comparison. However, the same could be achieved by correlating changes in the “port status” column of “devices” table to a certain API invocation, which may also be correlated with the change in the “state” column of the “equipment” table. These and other aspects of the present disclosure are described in greater detail below in connection with the examples of FIGS. 1-5.

To aid in understanding the present disclosure, FIG. 1 illustrates an example system 100 comprising a plurality of different networks in which examples of the present disclosure may operate. Telecommunication service provider network 150 may comprise a core network with components for telephone services, Internet services, and/or television services (e.g., triple-play services, etc.) that are provided to customers (broadly “subscribers”), and to peer networks. In one example, telecommunication service provider network 150 may combine core network components of a cellular network with components of a triple-play service network. For example, telecommunication service provider network 150 may functionally comprise a fixed-mobile convergence (FMC) network, e.g., an IP Multimedia Subsystem (IMS) network. In addition, telecommunication service provider network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Telecommunication service provider network 150 may also further comprise a broadcast television network, e.g., a traditional cable provider network or an Internet Protocol Television (IPTV) network, as well as an Internet Service Provider (ISP) network. With respect to television service provider functions, telecommunication service provider network 150 may include one or more television servers for the delivery of television content, e.g., a broadcast server, a cable head-end, a video-on-demand (VoD) server, and so forth. For example, telecommunication service provider network 150 may comprise a video super hub office, a video hub office and/or a service office/central office.

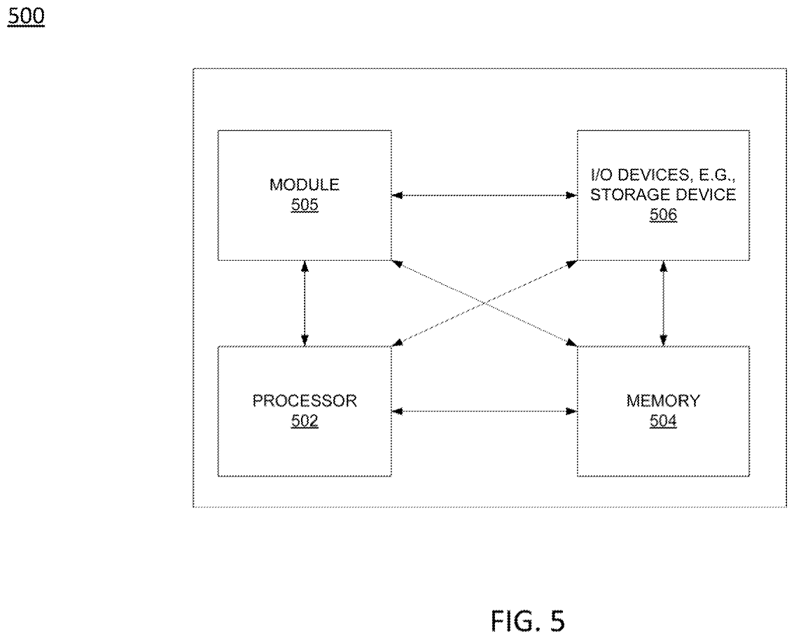

In one example, telecommunication service provider network 150 may also include one or more servers 155. In one example, the servers 155 may each comprise a computing device or processing system, such as computing system 500 depicted in FIG. 5, and may be configured to host one or more centralized and/or distributed system components. For example, a first system component may comprise a database of assigned telephone numbers, a second system component may comprise a database of basic customer account information for all or a portion of the customers/subscribers of the telecommunication service provider network 150, a third system component may comprise a cellular network service home location register (HLR), e.g., with current serving base station information of various subscribers, and so forth. Other system components may include a Simple Network Management Protocol (SNMP) trap, or the like, a billing system, a customer relationship management (CRM) system, a trouble ticket system, an inventory system (IS), an ordering system, an enterprise reporting system (ERS), an account object (AO) database system, and so forth. In addition, other system components may include, for example, a layer 3 router, a short message service (SMS) server, a voicemail server, a video-on-demand server, a server for network traffic analysis, and so forth. It should be noted that in one example, a system component may be hosted on a single server, while in another example, a system component may be hosted on multiple servers in a same or in different data centers or the like, e.g., in a distributed manner. For ease of illustration, various components of telecommunication service provider network 150 are omitted from FIG. 1.

In one example, access networks 110 and 120 may each comprise a Digital Subscriber Line (DSL) network, a broadband cable access network, a Local Area Network (LAN), a cellular or wireless access network, and the like. For example, access networks 110 and 120 may transmit and receive communications between endpoint devices 111-113, endpoint devices 121-123, and service network 130, and between telecommunication service provider network 150 and endpoint devices 111-113 and 121-123 relating to voice telephone calls, data communications, communications with web servers via the Internet 160, and so forth. Access networks 110 and 120 may also transmit and receive communications between endpoint devices 111-113, 121-123 and other networks and devices via Internet 160. For example, one or both of the access networks 110 and 120 may comprise an ISP network, such that endpoint devices 111-113 and/or 121-123 may communicate over the Internet 160, without involvement of the telecommunication service provider network 150. Endpoint devices 111-113 and 121-123 may each comprise a telephone, e.g., for analog or digital telephony, a mobile device, such as a cellular smart phone, a laptop, a tablet computer, etc., a router, a gateway, a desktop computer, a plurality or cluster of such devices, a television (TV), e.g., a “smart” TV, a set-top box (STB), and the like. In one example, any one or more of endpoint devices 111-113 and 121-123 may represent one or more user/subscriber devices. In addition, in one example, any of the endpoint devices 111-113 and 121-123 may comprise a device of an end-user (e.g., of an abstract data visualization service, as referred to herein).

In one example, the access networks 110 and 120 may be different types of access networks. In another example, the access networks 110 and 120 may be the same type of access network. In one example, one or more of the access networks 110 and 120 may be operated by the same or a different service provider from a service provider operating the telecommunication service provider network 150. For example, each of the access networks 110 and 120 may comprise an Internet service provider (ISP) network, a cable access network, and so forth. In another example, each of the access networks 110 and 120 may comprise a cellular access network, implementing such technologies as: global system for mobile communication (GSM), e.g., a base station subsystem (BSS), GSM enhanced data rates for global evolution (EDGE) radio access network (GERAN), or a UMTS terrestrial radio access network (UTRAN) network, among others, where telecommunication service provider network 150 may comprise a public land mobile network (PLMN)-universal mobile telecommunications system (UMTS)/General Packet Radio Service (GPRS) core network, or the like. In still another example, access networks 110 and 120 may each comprise a home network or enterprise network, which may include a gateway to receive data associated with different types of media, e.g., television, phone, and Internet, and to separate these communications for the appropriate devices. For example, data communications, e.g., Internet Protocol (IP) based communications may be sent to and received from a router in one of the access networks 110 or 120, which receives data from and sends data to the endpoint devices 111-113 and 121-123, respectively.

In this regard, it should be noted that in some examples, endpoint devices 111-113 and 121-123 may connect to access networks 110 and 120 via one or more intermediate devices, such as a home gateway and router, an Internet Protocol private branch exchange (IPPBX), and so forth, e.g., where access networks 110 and 120 comprise cellular access networks, ISPs and the like, while in another example, endpoint devices 111-113 and 121-123 may connect directly to access networks 110 and 120, e.g., where access networks 110 and 120 may comprise local area networks (LANs), enterprise networks, and/or home networks, and the like.

In one example, the service network 130 may comprise a local area network (LAN), or a distributed network connected through permanent virtual circuits (PVCs), virtual private networks (VPNs), and the like for providing data and voice communications. In one example, the service network 130 may be associated with the telecommunication service provider network 150. For example, the service network 130 may comprise one or more devices for providing services to subscribers, customers, and/or users. For example, telecommunication service provider network 150 may provide a cloud storage service, web server hosting, and other services. As such, service network 130 may represent aspects of telecommunication service provider network 150 where infrastructure for supporting such services may be deployed.

In one example, the service network 130 links one or more devices 131-134 with each other and with Internet 160, telecommunication service provider network 150, devices accessible via such other networks, such as endpoint devices 111-113 and 121-123, and so forth. In one example, devices 131-134 may each comprise a telephone for analog or digital telephony, a mobile device, a cellular smart phone, a laptop, a tablet computer, a desktop computer, a bank or cluster of such devices, and the like. In an example where the service network 130 is associated with the telecommunication service provider network 150, devices 131-134 of the service network 130 may comprise devices of network personnel, such as customer service agents, sales agents, marketing personnel, or other employees or representatives who are tasked with addressing customer-facing issues and/or personnel for network maintenance, network repair, construction planning, and so forth. Similarly, devices 131-134 of the service network 130 may comprise devices of network personnel responsible for operating and/or maintaining various data storage systems (e.g., database administrators).

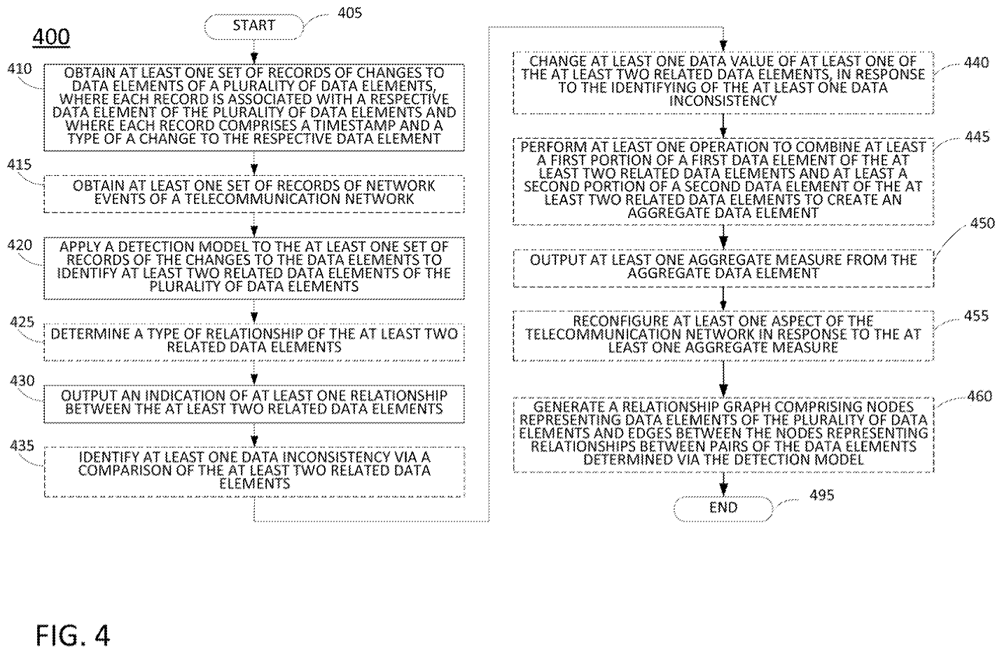

In the example of FIG. 1, service network 130 may include one or more servers 135 which may each comprise all or a portion of a computing device or processing system, such as computing system 500, and/or a hardware processor element 502 as described in connection with FIG. 5 below, specifically configured to perform various steps, functions, and/or operations for applying a detection model to at least one set of records of changes to data elements of a plurality of data elements to identify at least two related data elements, as described herein. For example, one of the server(s) 135, or a plurality of servers 135 collectively, may perform operations in connection with the example method 400 of FIG. 4, or as otherwise described herein. Similarly, one or more of the server(s) 135 may represent a data consistency platform or processing system. In other words, one or more of the server(s) 135 may provide a data consistency service and/or a data element relationship identification service.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device, or computing system, including one or more processors, or cores (e.g., as illustrated in FIG. 5 and discussed below) or multiple computing devices collectively configured to perform various steps, functions, and/or operations in accordance with the present disclosure.

In one example, service network 130 may also include one or more databases (DBs) 136, e.g., data repositories comprising physical storage devices integrated with server(s) 135 (e.g., database servers), attached or coupled to the server(s) 135, and/or in remote communication with server(s) 135 to store various types of information in support of examples of the present disclosure for applying a detection model to at least one set of records of changes to data elements of a plurality of data elements to identify at least two related data elements. As just one example, DB(s) 136 may be configured to receive and store network operational data collected from the telecommunication service provider network 150, such as call logs, mobile device location data, control plane signaling and/or session management messages, data traffic volume records, call detail records (CDRs), error reports, network impairment records, performance logs, alarm data, television usage information, such as live television viewing, on-demand viewing, etc., and other information and statistics.

In accordance with the present disclosure, a data set may comprise a number of data elements selected from data of these data sources (e.g., at least a portion of the records from each of these data sources). For instance, in the case of mobile device location data, new location data is continuously collected by the telecommunication service provider network 150. This data may be added as new records to DB(s) 136 on an ongoing basis, e.g., hourly, daily, etc. In addition old mobile device location data records may be released from DB(s) 136 on an ongoing basis and/or may be aggregated, averaged, etc., and stored as new processed data in DB(s) 136. Thus, for purposes of the present disclosure a data element may comprise at least a portion of the data from one of these sources, e.g., all currently available records, currently available records for a given time interval (e.g., where multiple data elements may be associated with different time intervals of available data from a same source), and so forth. In this regard, it should be noted that a data element may comprise a data table, a row of data, and/or a column of data. In one example, a data set may comprise a plurality of data tables (e.g., data objects) that may have defined relationships, or which may have unknown/undefined relationships. In one example, relationships among data elements (e.g., table-to-table, column-to-column, etc.) may be learned via extract, transform, and load (ETL) processing and/or automated data profiling operations in accordance with the present disclosure, and added to the respective data element(s) and/or data set(s) as metadata (e.g., as part of a data element or data set “profile”).

In one example, data from server(s) 155 may be further compiled and processed, e.g., normalized, transformed, tagged, etc. (e.g., ETL processing) for storage as further data elements within DB(s) 136. In one example, data elements may be further organized into one or more data sets via an ETL process, such as in accordance with a system operator configuration that defines ownership and/or other associations of data elements to data sets. In one example, a data element may belong to more than one data set. In another example, a data element may be replicated such that different data sets have respective copies of the data element. In one example, network operational data may further include data and/or records collected from access networks 110 and 120 (e.g., where access networks 110 and 120 are a part of and/or controlled by telecommunication service provider network 150), such as from cellular base station equipment, data reported by and collected from endpoint devices 111-113 and 121-123, or the like, and so forth.

In one example, DB(s) 136 may be configured to receive and store records from customer, user, and/or subscriber interactions, e.g., with customer facing automated systems and/or personnel of a telecommunication network service provider or other entities associated with the service network 130. For instance, DB(s) 136 may maintain call logs and information relating to customer communications which may be handled by customer agents via one or more of the devices 131-134. For instance, the communications may comprise voice calls, online chats, etc., and may be received by customer agents at devices 131-134 from one or more of devices 111-113, 121-123, etc. The records may include the times of such communications, the start and end times and/or durations of such communications, the touchpoints traversed in a customer service flow, results of customer surveys following such communications, any items or services purchased, the number of communications from each user, the type(s) of device(s) from which such communications are initiated, the phone number(s), IP address(es), etc. associated with the customer communications, the issue or issues for which each communication was made, etc. For instance, there may be different data elements comprising records of customers' voice calls, customers' text chats, and customers' online interactions, respectively, which may be associated with one or more data sets.

Alternatively, or in addition, any one or more of devices 131-134 may comprise an interactive voice response system (IVR) system, a web server providing automated customer service functions to subscribers, etc. In such case, DB(s) 136 may similarly maintain records of customer, user, and/or subscriber interactions with such automated systems (e.g., as one or more data elements, such as tables, or rows and/or columns within one or more tables). The records may be of the same or a similar nature as any records that may be stored regarding communications that are handled by a live agent. Similarly, any one or more of the devices 131-134 may comprise a device deployed at a retail location that may service live/in-person customers. In such case, the one or more of devices 131-134 may generate records that may be forwarded and stored by DB(s) 136. The records may comprise purchase data, information entered by employees regarding inventory, customer interactions, surveys responses, the nature of customer visits, etc., coupons, promotions, or discounts utilized, and so forth. In still another example, any one or more of the devices 111-113 or 121-123 may comprise a device deployed at a retail location that may service live/in-person customers and that may generate and forward customer interaction records to DB(s) 136. The records may be maintained as one or more data elements, such as data tables that contain records for different time blocks (e.g., different data tables for different days' records), data tables that contain records from different locations (e.g., a first table may store records from a first retail location, while a second table may store records from a second retail location, and so forth).

Thus, the various data and/or records collected from various components of telecommunication service provider network 150 (e.g., server(s) 155), access networks 110 and 120, and/or service network 130 may be organized into data tables. This includes both “streaming” and “batch” data, or both “data at rest” and “data in motion.” In one example, the data elements may be collected as one or more “data sets” or may be assigned to/associated with one or more data sets as received. Alternatively, or in addition, data elements may be assigned to one or more data sets after being received at DB(s) 136.

In one example, DB(s) 136 may alternatively or additionally receive and/or store data from one or more external entities. For instance, DB(s) 136 may receive and store weather data or traffic data from a device of a third-party, e.g., a weather service, a traffic management service, etc. via one of the access networks 110 or 120. To illustrate, one of the endpoint devices 111-113 or 121-123 may represent a weather data server (WDS). In one example, the weather data may be received via a weather service data feed, e.g., an NWS extensible markup language (XML) data feed, or the like. In another example, the weather data may be obtained by retrieving the weather data from the WDS. In one example, DB(s) 136 may receive and store weather data from multiple third-parties. In still another example, one of the endpoint devices 111-113 or 121-123 may represent a server of a traffic management service and may forward various traffic related data to DB(s) 136, such as toll payment data, records of traffic volume estimates, traffic signal timing information, reported accidents and their locations, and so forth. Similarly, one of the endpoint devices 111-113 or 121-123 may represent a server of a bank, an insurance entity, a medical provider, a consumer credit entity (e.g., a credit bureau, a credit card company, etc.), a merchant, or the like. In such an example, DB(s) 136 may obtain one or more data sets comprising information such as: consumer credit scores, credit reports, purchasing information and/or credit card payment information, credit card usage location information, and so forth (e.g., as one or more data elements, such as tables, table columns, etc.). Alternatively, or in addition DB(s) 136 may receive the same or similar data as one or more data feeds, which may be organized into one or more data sets comprising one or more data tables to be stored by DB(s) 136. In one example, one of the endpoint devices 111-113 or 121-123 may represent a server of an online social network, an online gaming community, an online news service, a streaming media service, or the like. In such an example, DB(s) 136 may obtain one or more data sets/data feeds comprising information such as: connections among users, specific media or types of media accessed, the access times, the durations of media consumption, games played, durations of game play, and so forth. It should be noted that for all of the above examples, the data, records, or other information collected from external entities may also be organized into and referred to as “data elements.” In one example, the data elements may be received as one or more “data sets,” or may be assigned to one or more data sets after being received at DB(s) 136.

In accordance with the present disclosure, DB(s) 136 may further store metadata associated with various data sets and/or data elements, data schema(s) (e.g., for data formatting, data naming, data size, etc.), and so forth. In one example, the metadata may include profiles of data sets (which may include profiles of data elements of the data sets). For instance, a profile of a data element may comprise the characteristics thereof, such as for a data column, a data type of the column, a mean of the column values, a median, a standard deviation, a high value, a low value, a uniqueness metric, and so forth. In accordance with the present disclosure, the profile may further include identifications of one or more related data elements (e.g., as determined in accordance with the present examples).

In one example, DB(s) 136 may store records of changes to data elements. In other words, records of “adds,” “deletes,” “modifications,” etc. may be stored as one or more additional data elements. For example, each data element may be represented by a set of time-stamped data records relating to the changes to the data element (e.g., all adds, deletes, modifies, etc.), in other words a time-series. In one example, DB(s) 136 may store aggregated records of changes to data elements, where time series for different data elements may be extracted from the aggregated records. Similarly, in one example, DB(s) 136 may store time-stamped records of “network events,” e.g., API calls or the like. Notably, this may comprise an additional time series that may be used to identify correlations/relationships of data elements. For instance, data elements that may be found to correlate to the same network events may be inferred to be correlated with each other.

In addition, with respect to all of the above examples, it should be noted that the data sets and/or data elements of data sets may be accessed by server(s) 135 and/or DB(s) 136 via application programming interfaces (APIs) or other access mechanisms between computing systems, and may include data that is specifically formatted and/or processed so as to maintain user privacy and/or anonymity, and/or such that the data that is accessed is in accordance with user-granted permissions, preferences, or the like, as well as any applicable contractual, legal, and/or regulatory obligations of either the provider(s) of such data, and/or the operator of server(s) 135 and/or DB(s) 136, as an accessor of the data.

In accordance with the present disclosure, DB(s) 136 may also store one or more relationship detection models for identifying correlations, or relationships between data elements. In one example, the relationship detection model(s) may comprise one or more machine learning algorithms (MLAs) and/or trained MLAs, e.g., MLMs that are trained with training data for various purposes, such as prediction, classification, etc. It should be noted that as referred to herein, a machine learning model (MLM) (or machine learning-based model) may comprise a machine learning algorithm (MLA) that has been “trained” or configured in accordance with input training data to perform a particular service. For instance, an MLM may comprise a deep learning neural network, or deep neural network (DNN), a convolutional neural network (CNN), a generative adversarial network (GAN), a decision tree algorithm/model, such as gradient boosted decision tree (GBDT) (e.g., XGBoost, XGBR, or the like), a support vector machine (SVM), e.g., a non-binary, or multi-class classifier, a linear or non-linear classifier, k-means clustering and/or k-nearest neighbor (KNN) predictive models, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. It should be noted that various other types of MLAs and/or MLMs, or other clustering and/or classification models may be implemented in examples of the present disclosure.

As noted above, each data element may be represented by a time series of data records relating to the changes to the data element (e.g., all adds, deletes, modifies, etc.). In one example, correlation/similarity between data elements may then be quantified in accordance with a distance metric based on the time series (e.g., each comprising a vector). In one example, the vectors may comprise the values within the time series. In this case the “values” may be the types of changes that occur (e.g., add, delete, modify, etc.). In one example, a time series comprising all of the changes to a data element may be modified to represent each type of change independently, e.g., a first time series/vector representing the timing of all “adds,” a second time series/vector representing the timing of all “deletes,” and so forth. In one example, the present disclosure may then calculate distance metrics with respect to these derived time series/vectors (e.g., as an alternative or in addition to the original time series/vector). In one example, data elements having time series that are within a threshold distance/distance metric of one another may be identified as “related,” or “correlated.” In one example, the strength or degree of relationship may be represented by the inverse of the distance/distance metric, e.g., a “relationship score” or “correlation score.” In other words, a pair of time series having a lower distance metric may be considered to have a stronger relationship than a pair of time series with a larger distance metric. In one example, similarity between/among time series may be calculated according to a dynamic time warping (DTW) distance measure based upon the values of time series. In this case the “values” may be the types of changes that occur (e.g., add, delete, modify, etc.). Notably, DTW accounts for time offsets. Thus, changes in a second data element that typically follow changes in a first data element by some time delay may still be correlated via DTW. In one example, other distance metrics may alternatively or additionally be used, such as a Euclidean distance, a cosine distance, and so forth.

In one example, the present disclosure may also represent some or all time series by their inverses, e.g., to determine negative correlations between time series. For instance, if an “add” in a first data element is always/usually followed or accompanied by a “delete” in a second data element, this type of relationship may be identified via the relationship detection model (e.g., by modeling at least one of the time series associated with one of the data elements as its inverse). In one example, the present disclosure may model time series by generating Fourier transforms of the time series and calculating a distance metric (e.g., between two time series/vectors) based on differences between values of each of the spectral features. This may be useful where changes in data elements follow periodic patterns. For instance, records for VNFs may be added and deleted as VNFs are instantiated and released daily. In one example, a VNF may be decommissioned at a first data center and respawned at a different data center based on time of day (e.g., a VNF for load-balancing may be decommissioned from a data center in California at 1:00 AM PT, while another VNF to perform the same function may be respawned at 4:00 AM ET in readiness for a next workday in New York). In this case, different data tables may store the corresponding records, which may have add operations and delete operations that occur essentially in unison. Other similar processes may occur at different periodic intervals, which may contribute to different spectral components when representing time series/vectors for the respective data tables in the spectral domain.

In one example, vectors representing time series may comprise a combination of time-domain data (e.g., the original time series) and generated spectral domain data points. Alternatively, or in addition, the vector may also comprise various characteristics derived from the time series, such as any of 200 or more highly comparative time-series analysis (HCTSA) features, canonical time-series characteristics (“catch22”) features, or the like. In one example, initial distance metrics may be calculated with respect to original time series/vectors. Thereafter, supplemental distance metrics may be calculated with respect to spectral domain transformations and/or vectors of derived features. In one example, the supplemental distance metrics may comprise separate outputs to be reported along with the initial distance metrics. In another example, the initial distance metrics may represent a matching score that may be modified (e.g., up or down) depending in the supplemental distance metric(s).

In accordance with the present disclosure, a relationship detection model may comprise tunable parameters relating to the features of interest for which similarity among time series may be determined/calculated. For instance, in one example, user-selectable factors may include: a type of distance metric from among several available distance metric types (e.g., DTW, Euclidean distance, cosine distance, etc.), whether spectral domain representations are to be used for calculating distance metrics, whether such distance metrics are to be used for a main measure of similarity or as a supplemental/secondary measure of similarity, whether a distance metric is to be calculated on derived characteristics of the time series, and if so, which characteristics are to be used, any weighting to be applied to the characteristics, and so forth.

In one example, the present disclosure may comprise a time-series clustering algorithm, such as k-means clustering or variants thereof (e.g., partitioning around medioids (PAM), k-medioid, etc.), density-based spatial clustering of applications with noise (DBSCAN) (which may provide superior performance, since data elements/time series that are not correlated with others may not be forced into a cluster and will be treated as outliers), etc. However, in one example, the clustering may be omitted while the distances between time series may still be calculated to determine relationships (e.g., where the distance between two time series/vectors is below a threshold distance, the associated data elements may be identified as “related”). The clustering model may be based on original time series/vectors and/or based on any of the derived vectors described above. In one example, related data elements may be identified when two or more data elements belong to a same cluster. In one example, additional analysis may be applied after two or more data elements are determined to be related (e.g., in the same cluster). For instance, each data element represented in the cluster may then be pair-wise compared to other data elements in the same cluster, e.g., via calculating a distance between spectral domain vector representations, vector representations based on other derived features, and so forth.

In still another example, one or more classifiers may be used to determine relationships between data elements in a data set. For instance, a time series representing a first data element may be used to train a classification model. Another time series may then be applied as an input to the classifier, wherein an output of the classifier may comprise a prediction/score of whether the input is or is not a member of the class. The classifiers may comprise, for example, a binary classifier or multi-class classifier, a linear or non-linear classifier, k-means clustering and/or KNN predictive classifier, a decision tree-base classifier, and so forth.

In one example, the same or similar processes as described above may be applied to identify correlations between data elements and network events. For instance, records of network events (e.g., API calls, trouble tickets, work order state changes, or the like) may be timestamped and recorded in DB(s) 136. In one example, the network event may be classified into a type of network event (e.g., API call, trouble ticket, etc. and/or a type of API operation, a type of trouble ticket, etc.). In one example, the record for a network event may also identify one or more network entities involved (e.g., a device or system making an API call, a target device or system to which the API call is directed, etc.). In one example, the network events may be segregated by sending system, receiving system, sending system-receiving system pairs, or the like. In other words, the network events may be organized into time series. Thus, similar to the above, distance metrics may be calculated between the time series representing network events and various time series representing changes to data elements.

In one example, the output(s) of a relationship detection model may comprise pairs of data elements that are determined to have a relationship, e.g., that are correlated, such as having a distance metric below a threshold or a relationship score (such as an inverse of the distance metric or the like) above a threshold, etc. In one example, the output(s) may comprise data element-network event pairs for which a relationship is determined. In one example, the output(s) may comprise the distance metrics and/or relationship scores. In one example, one or more distance metrics below a threshold and/or one or more relationship scores above a threshold may be the output. Alternatively, or in addition, all relationship scores may be recorded, and may be the output or made available upon request. For instance, a user may select to see any relationship score or distance metric between two data elements of the user's choosing. In one example, the output(s) of a relationship detection model may comprise one or more clusters of data elements. For instance, as described above, in one example, a relationship detection model may comprise a time-series clustering algorithm, in which case, the clusters may be generated via such a model and presented as an output. In one example, clusters may be filtered so as to omit clusters with only weak connections between members, or the like from presentation, such as via a visualization on a screen of a user endpoint device. For instance, the clusters may be presented via a 2D or 3D projection.

In view of the above, it should be noted that in one example, server(s) 135 may extract sets of records from DB(s) 136 comprising time-stamped records of changes to data elements (and in one example additionally comprising time-stamped network event records) and may apply the sets of records to one or more relationship detection models (e.g., implemented by server(s) 135) to obtain clusters of related data elements (and/or network event-data element pairs) and/or metrics of relationship strength among data elements (and/or between network events and data elements), etc. In one example, server(s) 135 may perform such operations on an ongoing basis, and may maintain the relationships that are identified as additional records stored in DB(s) 136, the metrics thereof (e.g., distance metrics and/or relationships scores, or the like), etc.

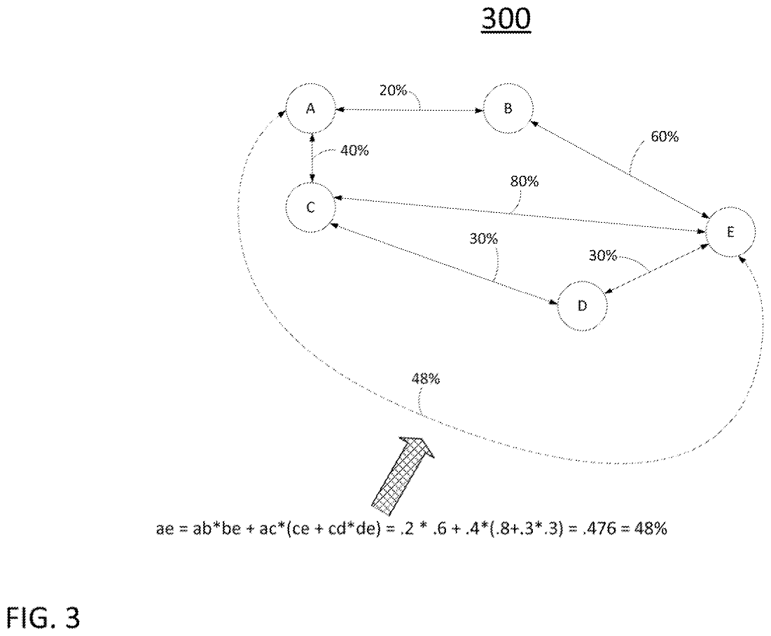

In one example, server(s) 135 may generate and/or maintain a graph of data elements and relationships. For instance, nodes may represent data elements, and the edges may represent the relationships between the data elements (e.g., for data elements pairs for which relationships were determined). In one example, the edges may be weighted with the distance metrics and/or relationship scores. In one example, the graph may be used to infer further relationships, and the strengths of such relationships, based on sequences of direct relationships in the graph. In this regard, an example graph 300 is illustrated in FIG. 3 and described in greater detail below.

In one example, server(s) 135 may perform additional operations such as confirming relationships and/or further defining the nature of relationships via further analysis. For example, server(s) 135 may compare data elements, such as table columns, in accordance with the actual data contained therein, such as statistical metrics, e.g., mean, median, high value, low value, entropy, uniqueness factor, etc. In one example, a relationship score may be adjusted based on a level of matching based on one or more of these other factors. For instance, a matching score may be generated based on a difference between the two data elements in accordance with a weighted combination of such factors. In one example, such a matching score may be further combined (e.g., in a weighted combination) with the distance metric and/or relationship score determined in accordance with the present disclosure, as described above, to generate a composite relationship metric. Thus, these and other modifications are all contemplated within the scope of the present disclosure.

In one example, server(s) 135 and/or DB(s) 136 may comprise cloud-based and/or distributed data storage and/or processing systems comprising one or more servers at a same location or at different locations. For instance, DB(s) 136, or DB(s) 136 in conjunction with one or more of the servers 135, may represent a distributed file system, e.g., a Hadoop® Distributed File System (HDFS™), or the like. As noted above, in one example, one or more of servers 135 may comprise a processing system that is configured to perform operations for applying a detection model to at least one set of records of changes to data elements of a plurality of data elements to identify at least two related data elements, as described herein. For instance, a flowchart of an example method 400 for applying a detection model to at least one set of records of changes to data elements of a plurality of data elements to identify at least two related data elements is illustrated in FIG. 4 described in greater detail below.

In addition, it should be realized that the system 100 may be implemented in a different form than that illustrated in FIG. 1, or may be expanded by including additional endpoint devices, access networks, network elements, application servers, etc. without altering the scope of the present disclosure. As just one example, any one or more of server(s) 135 and DB(s) 136 may be distributed at different locations, such as in or connected to access networks 110 and 120, in another service network connected to Internet 160 (e.g., a cloud computing provider), in telecommunication service provider network 150, and so forth. Thus, these and other modifications are all contemplated within the scope of the present disclosure.

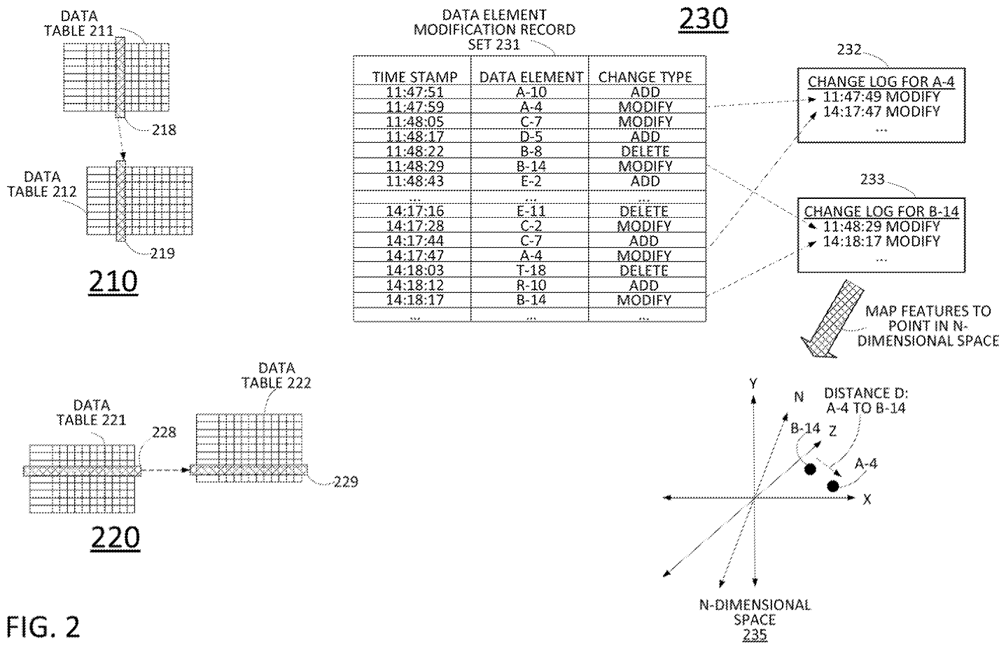

To further aid in understanding the present disclosure FIG. 2 illustrates several aspects of identifying relationships between data elements. A first example 210 illustrates that a relationship may be identified between columns (e.g., “data elements”) of different data tables. For instance, column 218 of data table 211 may be correlated with column 219 of data table 212. In other words, columns 218 and 219 may be determined to have a relationship in a manner as described above. For instance, respective time series may comprise data regarding the changes, and the timing thereof, of the respective columns 218 and 219. Similarly, a second example 220 illustrates that a relationship may be identified between rows (e.g., “data elements”) of different data tables. For instance, row 228 of data table 221 may be correlated with row 229 of data table 222. In other words, rows 228 and 229 may be determined to have a relationship in a manner as described above. For instance, respective time series may comprise data regarding the changes, and the timing thereof, of the respective rows 228 and 229. It should be noted that although the examples 210 and 220 illustrate the identification of relationships between data elements of different tables, in another example, the present disclosure may be applied to identify relationships between data elements in a same table. Although relationships among data elements in a same table may be well defined, e.g., in the table schema or the like, it is possible that a data table is not well-documented, or was generated by personnel who have since left an organization and who may be unavailable to share knowledge on the origin of the data in a table, the structure of the table, external entities that may make changes to the table and under what conditions, and so forth. Thus, it may still be valuable to identify intra-table relationships in an automated way in accordance with the present disclosure.

A third example 230 in FIG. 2 illustrates a process of correlating two data elements from a set of time-stamped records of data element changes. For instance, data element modification record set 231 includes a plurality of records, each comprising a time stamp, an affected data element, and a type of change (e.g., add, delete, modify, etc.). In the present example, the data elements may comprise table columns. For instance, data element A-10 may refer to column 10 of table A, data element C-7 may refer to column 7 of table C, and so forth. However, it should be noted that in other, further, and different example, a data element modification record set may comprise records organized by changes to rows, or changes to tables overall.

In the present example, respective time series 232 and 233 may be extracted from the data element modification record set 231 comprising records associated with data element A-4 and data element B-14, respectively. For instance, time series 232 may represent a change log for data element A-4, while time series 233 may represent a change log for data element B-14. In this case, it can be seen that when A-4 is modified at time 11:47:49, B-14 is modified 30 seconds later at time 11:48:29. Similarly, when A-4 is modified at time 14:17:47, B-14 is modified 30 seconds later at time 14:18:17. Although FIG. 2 may depict just a small snapshot of data element modification record set 231, for illustrative purposes, it may be assumed that a similar pattern of B-14 being modified 30 seconds after modifications to A-4 may be found throughout the data element modification record set 231.

As described above, a relationship between these data elements may be determined in accordance with a relationship detection model. For instance, the relationship detection model may provide for a distance metric such as a DTW distance metric, a cosine distance, or the like. Alternatively, or in addition, the relationship detection model may comprise a clustering model. In one example, the time series 232 and 233 may be represented as points in a multi-dimensional space (e.g., n-dimensional space 235) in accordance with such a clustering model. A distance “D” (or distance metric) may then be calculated based upon a distance between the points in the n-dimensional space 235. For illustrative purposes, it may be assumed that this distance “D” is below a threshold for which a relationship, or correlation between data elements A-4 and B-14 may be declared.

It should be noted that different time series may be extracted from data element modification record set 231 for various other data elements. In addition, these various other data elements may be considered for identification of possible relationships with data elements A-4 and B-14, and/or with each other. In one example, a clustering model may perform a clustering process with respect to data elements A-4 and B-14 along with all of these various other data elements. It should also be noted that for purposes of comparison (e.g., calculating a distance metric and/or clustering) the time series 232 and 233 may represent a bounded set extracted from a potentially unbounded stream (e.g., data element modification record set 231 may be appended on an ongoing basis, where periodically, old entries may be flushed from the set). For example, time series 232 and 233 may represent 12 hours of records, 24 hours of records, 72 hours of records, two weeks of records, etc. In one example, the present disclosure may repeat calculations of relationships metrics (e.g., distance metrics) and/or re-perform clustering using sliding time windows, e.g., looking at the past 12 hours every 12th hour, looking at the past day's records each next day, etc. In one example, cluster changes and/or changes in relationship metrics may also be recorded and may be provided as additionally useful output information. Thus, these and other modifications are all contemplated within the scope of the present disclosure.

FIG. 3 illustrates an example relationship graph 300 that may be generated in accordance with the present disclosure. For instance, as depicted in the graph 300, there may be five nodes A-E representing different data elements (e.g., data elements A-E, which may comprise tables, table rows, or table columns, for instance). The lines between the nodes comprise the edges, or links of the graph and may represent relationships between the data elements associated with the respective nodes A-E. For instance, each edge may represent a relationship determined via one or more relationship detection model(s). As further illustrated in FIG. 3, each edge may have an edge weight (e.g., a label). In the present example, edge weights may comprise percentages. However, in other, further, and different examples, edge weights may have a different representation, such as a value on a scale of 0 to 10, 1 to 10, 1 to 5, −5 to +5, etc. In accordance with the present disclosure, the edge weights may comprise relationship scores (e.g., which may comprise or which may be based upon an inverse of a distance metric determined as described above). The relationship score (or relationship strength) may quantify how likely it is for one data element to be affected by another data element. In one example, the edges may represent relationships that have been determined directly between data elements. Alternatively, or in addition, at least a portion of the edges may represent relationships between data elements determined indirectly via correlation to a same type of network event. For instance, the edge between nodes B and E may have been identified in this manner.

Notably, for nodes in graph 300 that do not have an edge defining a node-node pair, the associated data elements may not have been determined to have a relationship, at least according to one or more relationship detection model(s) that may have been applied. However, in one example, the present disclosure may further quantify associations between data elements for which more direct relationships may not have been determined. For instance, the graph 300 may be traversed to find links among nodes (e.g., relationships among the data elements represented by such nodes) that may not be directly related (initially), but which may be related through one or more additional nodes. For instance, data element A may be indirectly associated with data element E via path A-B-E, path A-C-E, and path A-C-D-E. To illustrate, “oh” may comprise a confidence factor between A and B (e.g., a likelihood that A is similar to B, that A changes similar to B, and/or that A is affected by B, etc.). Similar confidence factors may be represented by “ac,” “be,” “ce,” “cd,” “de,” etc. Then, a strength of indirect association may be calculated as a sum of a multiplication of all paths from A to E. For instance, based on the confidence factors in graph 300 (e.g., the edge weights/relationship metrics): ae=ab*be+ac*(ce+cd*de)=0.2*0.6+0.4*(0.8+0.3*0.3)=0.476=48%. As such, the results of data element correlation such as described above may be further expanded in this way. In one example, indirect relationships may be added to the graph as additional links (such as the dotted line between A and E in the graph 300), or may be identified upon user request and output accordingly. It should be noted that FIG. 3 illustrates one way in which a measure of an indirect relationship may be calculated. However, other, further and different examples may calculate such a relationship metric in a different way, such as adding squares of component edge weights and taking a square root, or the like.

In another example, graph 300 may include nodes for network events and links to nodes for related data elements. For instance, API calls from system Y to system Z may be represented by a first node, API calls from system X to system W may be represented by a second node, etc. Alternatively, or in addition, a first node may represent API calls from system Y to system Z to “instantiate load balancing server,” a second node may represent API calls from system Y to system Z to “instantiate firewall,” a third node may represent API calls from system X to system W to “activate sleep mode,” a fourth node may represent API calls from system X to system V to “set maximum link utilization level,” and so forth. Thus, these and other modifications are all contemplated within the scope of the present disclosure.

FIG. 4 illustrates a flowchart of an example method 400 for applying a detection model to at least one set of records of changes to data elements of a plurality of data elements to identify at least two related data elements, according to the present disclosure. In one example, the method 400 is performed by a component of the system 100 of FIG. 1, such as by server(s) 135, and/or any one or more components thereof (e.g., a processor, or processors, performing operations stored in and loaded from a memory or distributed memory system), or by server(s) 135, in conjunction with one or more other devices, such as DB(s) 136, server(s) 155, and so forth. In one example, the steps, functions, or operations of method 400 may be performed by a computing device or processing system, such as computing system 500 and/or a hardware processor element 502 as described in connection with FIG. 5 below. For instance, the computing system 500 may represent at least a portion of a platform, a server, a system, and so forth, in accordance with the present disclosure. In one example, the steps, functions, or operations of method 400 may be performed by a processing system comprising a plurality of such computing devices as represented by the computing system 500. For illustrative purposes, the method 400 is described in greater detail below in connection with an example performed by a processing system (e.g., deployed in a telecommunication network). The method 400 begins in step 405 and proceeds to step 410.

At step 410, the processing system obtains at least one set of records of changes to data elements of a plurality of data elements, where each record is associated with a respective data element of the plurality of data elements and where each record comprises a timestamp and a type of a change to the respective data element. As discussed above, the plurality of data elements may comprise, for example, data tables, columns of the data tables, or rows of the data tables. As further discussed above, the type of change may comprise, for example, a data addition, a data deletion, a data modification, or the like. In one example, the at least one set of records may comprise at least two sets of records. For instance, a first set of records may be associated with a first data element and a second set of records may be associated with a second data element. As such, the first set of records may comprise a first time series, and the second set of records may comprise a second time series.

At optional step 415, the processing system may obtain at least one set of records of network events of a telecommunication network. For instance, the network events may comprise API calls associated with network elements of the telecommunication network, trouble tickets, work orders, state changes, or the like. As noted above, records of network events may be timestamped and may identify one or more network entities involved (e.g., a device or system making an API call, a target device or system to which the API call is directed, etc.). In one example, the network events may be segregated by sending system, receiving system, sending system-receiving system pairs, or the like. In other words, the network events may be organized into one or more time series.

At step 420, the processing system applies a detection model to the at least one set of records of the changes to the data elements to identify at least two related data elements of the plurality of data elements. In one example, step 420 may comprise an application of a time series distance metric. For instance, the time series distance metric may comprise a dynamic time warping (DTW) distance measure/metric. Alternatively, the distance metric may comprise a cosine distance, a Euclidean distance, or the like. For instance, as noted above, the at least one set of records may comprise at least two sets of records, where a first set of records may be associated with a first data element and where a second set of records may be associated with a second data element. As such, the first set of records may comprise a first time series, and the second set of records may comprise a second time series. In one example, the first data element and the second data element may be determined to be related when a distance (e.g., a DTW distance, etc.) between the first time series and the second time series is below a threshold distance. For instance, the threshold may be set by a system operator, may be adjusted dynamically so as to identify at least a defined percentage of data elements of the plurality of data elements as being related, and so forth.

In one example, the detection model may comprise a time-series clustering model. For instance, the time-series clustering model may be based on a DTW distance metric or the like. In one example, the clustering model may comprise a k-means clustering model. n another example, the clustering model may comprise a DBSCAN clustering model, and so forth. In such example, the first data element and the second data element may be determined to be related when the first data element and the second data element are determined to be associated with a same cluster. In still another example, the detection model may comprise another unsupervised machine learning model, such as a k-means clustering and/or KNN predictive classifier, a decision tree-base classifier, and so forth. In one example, the at least one set of records may comprise a unitary set of records comprising a multivariate time series (e.g., where each record indicates (1) the data element to which a change has occurred along with (2) the nature of the change). In such case, the detection model may be applied to extract relationships from an input set of records having such a format.

In one example, step 420 may comprise generating an inverse of one or both of the first time series or the second time series, generating a Fourier transform of one or both of the first time series or the second time series, and/or generating other derived time series. In addition, in one example, step 420 may further comprise calculating distance metrics between the one or more derived time series with each other and/or with the first and/or the second time series. In one example, step 420 may comprise applying the detection model to the at least one set of records of the changes to the data elements that may be obtained at step 410 and the at least one set of records of the network events that may be obtained at optional step 415. For instance, as noted above, in one example, at least two related data elements may be identified as being related when each of the two related data elements is determined to be related to a same network event type in accordance with the detection model.

At optional step 425, the processing system may determine a type of relationship of the at least two related data elements. For instance, the type of relationship may be determined via techniques, such as statistical analysis (e.g., determining high value, low value, mean, median, entropy measure, uniqueness factor, etc. and then comparing to confirm that data elements contain the same or similar values), via data type investigation (e.g., determining that two columns contain numeric values, determining that two columns contain addresses but do not appear to have the same addresses, etc.), via sampling analysis (e.g., sampling data to determine columns appear to contain the same data, reformatting column from high to low and sampling, etc.), and so on. The type of relationship may comprise for example, a “similar data” relationship type, a “positive dependence” relationship type, a “negative dependence” relationship type, a “subset of” relationship type, a “contains within” relationship type, an overlapping—with relationship type, a derived—from relationship type, a complement—to relationship type, and so forth.

At step 430, the processing system outputs an indication of at least one relationship between the at least two related data elements. For instance, the processing system may generate and store a list of related data elements. In one example, the processing system may record metadata with respect to at least one of the data elements indicative of a relationship with the other data element(s) identified at step 420, and so forth. For instance, the metadata may be appended to the data element(s) or may be stored separately but linked to the respective data element(s). Such metadata may also include statistics pertaining to the data elements, such as mean, median, high value, low value, entropy, uniqueness metrics, etc. In one example, the indication of the at least one relationship may include the type of relationship that may be determined at optional step 425. In one example, the output may be presented via a display screen of at least one endpoint device. For instance, an operator may select a data element and seek to identify any related data elements, which may be returned as output(s) at step 430 in response to such a selection/request.

At optional step 435, the processing system may identify at least one data inconsistency via a comparison of the at least two related data elements. For instance, if the data elements are supposed to comprise the same data, it may be determine that the one or more aspects of the data elements are not the same.

At optional step 440, the processing system may change at least one data value of at least one of the at least two related data elements, in response to the identifying of the at least one data inconsistency. For instance, in one example, the change may be based upon choosing at least one data entry of at least one of the data element that was most recently updated as the correct one. Alternatively, or in addition, optional step 440 may comprise undoing the most recent entry among two associated entries of the respective data elements. For instance, it may be the case that a service address should not have been changed when a billing address was changed.

At optional step 445, the processing system may perform at least one operation to combine at least a first portion of a first data element of the at least two related data elements and at least a second portion of a second data element of the at least two related data elements to create an aggregate data element. For instance, the at least one operation may comprise a join operation, a merge operation, an append operation, a union operation, a concatenate operation, or the like.

At optional step 450, the processing system may output at least one aggregate measure from the aggregate data element. For instance, data sets may be used for various purposes in a telecommunication network such as load balancing, instantiating VNFs, placing network elements in sleep mode, waking network elements, and so forth. In one example, various automated triggers based on such data sets may be updated or may have newly aggregated data sets used as inputs for more accurate assessment of network conditions, more accurate forecasting, and so forth.

At optional step 455, the processing may reconfigure at least one aspect of the telecommunication network in response to the at least one aggregate measure. For instance, as noted above, the plurality of data elements may comprise operational data records of a telecommunication network. Thus, the at least one aggregate measure may be derived from the aggregate data element, which may be used for various downstream purposes, e.g., reconfiguring at least one aspect of the telecommunication network. For instance, the telecommunication network may comprise a software defined network (SDN) and/or a self-optimizing network (SON). As such, the reconfiguring may comprise instantiating or releasing a VNF, such as a virtual firewall, a load balancing server, etc., instantiating or releasing a content distribution network (CDN) edge node, placing content in a CDN edge node or other nodes in anticipation of a demand forecast in accordance with the at least on aggregate measure, activating or deactivating remote radio heads (RHHs), baseband units (BBUs), and so forth, beam steering, and so on.

At optional step 460, the processing system may generate a relationship graph comprising nodes representing data elements of the plurality of data elements and edges between the nodes representing relationships between pairs of the data elements determined via the detection model. In one example, the edges may be assigned weights corresponding to distances between pairs of time series of records corresponding to associated pairs of related data elements (e.g., data elements having relationships determined via the detection model). In one example, the weights may be adjusted by a scaling factor when a relationship is determined via indirect association (e.g., two data elements determined to be related by virtue of being related to a same network event type). In one example, optional step 460 may include presenting the graph, e.g., via a display of a user endpoint device. Alternatively, or in addition, the graph may be used for calculation of additional relationships between data elements, such as illustrated and described in connection with the example graph 300 of FIG. 3.

Following step 430 or any of optional steps 435-460, the method 400 proceeds to step 495 where the method 400 ends.

It should be noted that the method 400 may be expanded to include additional steps, or may be modified to replace steps with different steps, to combine steps, to omit steps, to perform steps in a different order, and so forth. For instance, in one example the processing system may repeat one or more steps of the method 400, such as steps 410-430, steps 410-460, etc. for one or more additional data sets, for a same data set but with respect to records from different time windows, and so forth. In one example, the method 400 may include training a detection model, such as a decision tree-base classifier, a KNN predictive classifier, or the like. In one example, step 410 may be preceded or follow by a step of splitting a unitary set of records into two or more sets of records (e.g., one for each data element to be considered). In one example, the generating of a graph at optional step 460 may alternatively comprise part of the outputting step 430. In one example, the method 400 may be expanded or modified to include steps, functions, and/or operations, or other features described above in connection with the example(s) of FIGS. 1-3, or as described elsewhere herein. Thus, these and other modifications are all contemplated within the scope of the present disclosure.

In addition, although not expressly specified above, one or more steps of the method 400 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 4 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the example embodiments of the present disclosure.

FIG. 5 depicts a high-level block diagram of a computing system 500 (e.g., a computing device or processing system) specifically programmed to perform the functions described herein. For example, any one or more components, devices, and/or systems illustrated in FIG. 1, or described in connection with FIGS. 2-4, may be implemented as the computing system 500. As depicted in FIG. 5, the computing system 500 comprises a hardware processor element 502 (e.g., comprising one or more hardware processors, which may include one or more microprocessor(s), one or more central processing units (CPUs), and/or the like, where the hardware processor element 502 may also represent one example of a “processing system” as referred to herein), a memory 504, (e.g., random access memory (RAM), read only memory (ROM), a disk drive, an optical drive, a magnetic drive, and/or a Universal Serial Bus (USB) drive), a module 505 for applying a detection model to at least one set of records of changes to data elements of a plurality of data elements to identify at least two related data elements, and various input/output devices 506, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 502 is shown, the computing system 500 may employ a plurality of hardware processor elements. Furthermore, although only one computing device is shown in FIG. 5, if the method(s) as discussed above is implemented in a distributed or parallel manner for a particular illustrative example, e.g., the steps of the above method(s) or the entire method(s) are implemented across multiple or parallel computing devices, then the computing system 500 of FIG. 5 may represent each of those multiple or parallel computing devices. Furthermore, one or more hardware processor elements (e.g., hardware processor element 502) can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 502 can also be configured or programmed to cause other devices to perform one or more operations as discussed above. In other words, the hardware processor element 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the present module 505 for applying a detection model to at least one set of records of changes to data elements of a plurality of data elements to identify at least two related data elements (e.g., a software program comprising computer-executable instructions) can be loaded into memory 504 and executed by hardware processor element 502 to implement the steps, functions or operations as discussed above in connection with the example method(s). Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The processor (e.g., hardware processor element 502) executing the computer-readable instructions relating to the above described method(s) can be perceived as a programmed processor or a specialized processor. As such, the present module 505 for applying a detection model to at least one set of records of changes to data elements of a plurality of data elements to identify at least two related data elements (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may comprise a physical device, a hardware device, or a device that is discernible by the touch. More specifically, the computer-readable storage device or medium may comprise any physical devices that provide the ability to store information such as instructions and/or data to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
obtaining, by a processing system including at least one processor, at least one set of records of changes to data elements of a plurality of data elements, wherein each record is associated a respective data element of the plurality of data elements and wherein each record comprises a timestamp and a type of a change to the respective data element;
applying, by the processing system, a detection model to the at least one set of records of the changes to the data elements to identify at least two related data elements of the plurality of data elements; and
outputting, by the processing system, an indication of at least one relationship between the at least two related data elements.

2. The method of claim 1, wherein the type of the change comprises:
a data addition;
a data deletion; or
a data modification.

3. The method of claim 1, wherein the plurality of data elements comprises:
data tables;
columns of the data tables; or
rows of the data tables.

4. The method of claim 1, wherein the detection model comprises an unsupervised machine learning model.

5. The method of claim 1, wherein the applying of the detection model comprises an application of a time series distance metric.

6. The method of claim 5, wherein the at least one set of records comprises at least two sets of records, wherein a first set of records of the at least two sets of records is associated with a first data element of the plurality of data elements, and wherein a second set of records of the at least two sets of records is associated with a second data element of the plurality of data elements.

7. The method of claim 6, wherein the first set of records comprises a first time series, and wherein the second set of records comprises a second time series.

8. The method of claim 7, wherein the first data element and the second data element are determined to be related when a distance between the first time series and the second time series is below a threshold distance.

9. The method of claim 7, wherein the detection model comprises a time-series clustering model, and wherein the first data element and the second data element are determined to be related when the first data element and the second data element are determined to be associated with a same cluster.

10. The method of claim 1, further comprising:
identifying, by the processing system, in response to the indication of the at least one relationship between the at least two related data elements, at least one data inconsistency via a comparison of the at least two related data elements; and
changing, by the processing system, at least one data value of at least one of the at least two related data elements, in response to the identifying of the at least one data inconsistency.

11. The method of claim 1, further comprising:
performing, by the processing system, at least one operation to combine at least a first portion of a first data element of the at least two related data elements and at least a second portion of a second data element of the at least two related data elements to create an aggregate data element.

12. The method of claim 11, further comprising:
outputting, by the processing system, at least one aggregate measure from the aggregate data element.

13. The method of claim 12, wherein the plurality of data elements comprises operational data records of a telecommunication network, the method further comprising:
reconfiguring, by the processing system, at least one aspect of the telecommunication network in response to the at least one aggregate measure.

14. The method of claim 1, further comprising:
identifying, by the processing system, a type of relationship of the at least two related data elements, wherein the indication of the at least one relationship includes the type of relationship.

15. The method of claim 1, further comprising:
obtaining, by the processing system, at least one set of records of network events of a telecommunication network.

16. The method of claim 15, wherein the network events comprise at least one of:
application programing interface calls associated with network elements of the telecommunication network;
trouble tickets of the telecommunication network;
work orders of the telecommunication network; or
network state changes of the telecommunication network.

17. The method of claim 15, wherein the applying of the detection model comprises applying the detection model to the at least one set of records of the changes to the data elements and the at least one set of records of the network events, wherein the at least two related data elements are identified as being related when each of the at least two related data elements is determined to be related to a same network event type in accordance with the detection model.

18. The method of claim 1, further comprising:
generating, by the processing system, a relationship graph comprising nodes representing data elements of the plurality of data elements and edges between the nodes representing relationships between pairs of the plurality of data elements determined via the detection model.

19. A non-transitory computer-readable medium storing instructions which, when executed by a processing system including at least one processor, cause the processing system to perform operations, the operations comprising:
obtaining at least one set of records of changes to data elements of a plurality of data elements, wherein each record is associated a respective data element of the plurality of data elements and wherein each record comprises a timestamp and a type of a change to the respective data element;
applying a detection model to the at least one set of records of the changes to the data elements to identify at least two related data elements of the plurality of data elements; and
outputting an indication of at least one relationship between the at least two related data elements.

20. A device comprising:
a processor system including at least one processor; and
a computer-readable medium storing instructions which, when executed by the processing system, cause the processing system to perform operations, the operations comprising:
obtaining at least one set of records of changes to data elements of a plurality of data elements, wherein each record is associated a respective data element of the plurality of data elements and wherein each record comprises a timestamp and a type of a change to the respective data element;
applying a detection model to the at least one set of records of the changes to the data elements to identify at least two related data elements of the plurality of data elements; and
outputting an indication of at least one relationship between the at least two related data elements.
